(19) United States
(12) Patent Application Publication
(10) Pub. No.: US 2025/0013974 A1
(43) Pub. Date: Jan. 9, 2025

(54) SYSTEM AND METHODS FOR FULL AUTOMATION OF DOOR-TO-DOOR DELIVERY AND PICKUP OF POSTAL PACKAGES TO/FROM RESIDENTS IN HIGH-RISE BUILDING COMPLEXES USING DRONE-ROBOT COMBINATIONS

(71) Applicant: QUOC VIET LUONG, Castro Valley, CA (US)

(72) Inventor: QUOC VIET LUONG, Castro Valley, CA (US)

(21) Appl. No.: 18/348,918

(22) Filed: Jul. 7, 2023

(51) Int. Cl. G06Q 10/0835

(52) U.S. Cl. CPC G06Q 10/0835

(57) ABSTRACT

A method and a system for door-to-door pickup and delivery of postal packages to customers who live in high-rise building complexes are disclosed which comprise: a drone designed to pick up and/or deliver the postal packages from a central depot to a designated area in the high-rise building complexes; and a robot configured to cooperate with the drone to deliver and/or pick up the postal packages to/from the frontdoors of the customers.

### FIELD OF THE INVENTION

The present invention relates generally to postal delivery systems. More specifically, the present invention relates to a system and method of picking up and delivering postal packages to the frontdoors of residents in high-rise buildings.

### BACKGROUND OF THE INVENTION

High rise offices and residences such as condominium and business complexes have been in existence way before artificial intelligence (AI), robotics, and the Internet. These high-rises have elevators to take customers up and down in these buildings. There are different types of elevators including hydrolic elevators, cable elevators, electrical elevators, and smart elevators. There are elevators that have existed more than 100 years that are still in use. In general, it is difficult and expensive to modify and/or replace old elevators for modern uses such as robotics and wireless communication.

Recently, in the modern time, with the advent of robotics and drones or unmanned aerial vehicles (UAV), the demands for door to door postal package delivery to residents in high-rises have been increasing. There have been many attempts to meet these demands because it is convenient for residents living on high floors to have their postal packages to deliver to their front doorsteps. This is especially true when these residents are elderlys, handicapped, or rehabilitating patients. Many companies have conceptualized and tested balcony delivery drones that presumably deliver packages of foods and merchandizes to residents who live in urban high-rises. However, the concept of balcony delivering drones faces many unsolvable challenges such as wind turbulence, drone inherent malfunctions that create mishaps to the recipient addressees and people below. In addition, the delivering drones may free fall from high altitude to the ground causing dangers to the people below. Especially when the delivering drones are carrying heavy packages. Furthermore, there are many residents in high-rise apartments that do not have balconies.

Big corporations such as Amazon, Google, and Alphabet have been trying to use drone delivery services. But their progresses have been hampered by the difficulties in balcony deliveries described above, government regulations, and weak demands. In Shenzhen, China, the food delivery drones operated by Meituan make more than 100,000 deliveries in 2022. However, the Meituan does not have the drone deliver directly to the customers' frontdoors. Instead, Meituan sets up pickup kiosks close to the residential office buildings. The drones drop off deliveries at the kiosks. Obviously, the customers or Meituan's employees (runners) have to handle the deliveries afterward. Thus, Meituan's drone deliveries fail to deliver and pick up packages to and from the frontdoors of the customers. In addition, the Meituan's system is designed chiefly for food deliveries. The Meituan's system is silent regarding frontdoor pickup services for residents in high-rises. Similarly, Amazon, Google, and Alphabet's drones are designed to achieve balcony deliveries of postal packages. They are completely silent regarding the pickup side of the pickup and delivery services.

Therefore, what is needed is a new and complete pickup and delivery system that can safely and accurately pick up and deliver postal packages or ordered foods (to-go) to the frontdoors of the residents who live in urban high-rise buildings.

What is needed is a new method for pickup and delivery that can safely and accurately deliver postal packages or foods to the frontdoors of residents who live in urban high-rise buildings.

What is needed is a pickup and delivery system and method that can pick up and deliver postal packages or takeout foods to the frontdoors of residents who live in urban high-rises, avoiding the dangers of balcony delivery.

Furthermore, what is needed is a pickup and delivery system and method that avoid the problems of balcony delivery drones and still deliver and pick up postal packages to the frontdoors of the residents.

Finally, what is needed is a pickup and delivery system and method that are simple and cost-effective to implement without the need of replacing or modifying the existing elevator systems.

The combination of drones and smart robots disclosed in the present invention solve the above-described problems of the balcony delivering drones. In addition, the combination of drones and smart robots disclosed in the present invention provide the complete door-to-door pickup and delivery postal services to customers who live in high-rise building complexes.

### SUMMARY OF THE INVENTION

Accordingly, an object of the present invention is to provide a system for door-to-door pickup and delivery of postal packages to recipient addressees who live in a high-rise building complex which comprises: a drone designed to pick up and deliver the postal packages from a station to a designated area in the high-rise building complex; and a pickup and delivery robot working in coordination with the drone to pickup and deliver the postal packages from the designated area to the frontdoors of the customers.

Another object of the present invention is to provide a method for door-to-door pickup and delivery of postal packages to customers living in a high-rise building complexes, comprising: (a) delivering the postal packages from a postal station to a designated area in the high-rise building complexes using a drone; (b) transferring the postal packages from the drone to a delivery robot when the drone arrives at the designated area; (c) delivering the postal packages to the front door of each customer using the delivery robot; and (d) returning the delivery robot to the base.

Yet another object of the present invention is to provide a system and a method of pickup and delivering postal packages to customers who live in a high-rise building complexes without using the balconies and/or large window panels.

Another object of the present invention is to provide a system and a method for safe pickup and delivery of postal packages without the risk of causing injuries to the customers by the delivering drones.

Another object of the present invention is to provide a system and a method of pickup and delivering of postal packages without the risk of causing injuries to the people who are walking and working directly below the delivering drones.

Another object of the present invention is to provide a system and method that solves the problems and issues of balcony pickup and delivering drones or unmanned aerial vehicles (UVA).

Another object of the present invention is to provide a system and a method of pickup and delivery of postal packages without being adversely effected by the weather at the time of delivery to the customers.

Another object of the present invention is to provide a cost-effective and simple system and method of pickup and delivering of postal packages to the frontdoors of the customers and then returning to bases for next door-to-door delivery services.

These and other advantages of the present invention will no doubt become obvious to those of ordinary skill in the art after having read the following detailed description of the preferred embodiments, which are illustrated in the various drawing figures.

### BRIEF DESCRIPTION OF DRAWINGS

The accompanying drawings, which are incorporated in and form a part of this specification, illustrate embodiments of the invention and, together with the description, serve to explain the principles of the invention.

FIG. 1 illustrates a three-dimensional (3D) perspective diagram demonstrating a first arrangement of drone-robot pickup and delivery system designed to safely and accurately accomplish door-to-door services of high-rise building complexes in accordance with one exemplary embodiment of the present invention;

FIG. 2 illustrates a three-dimensional (3D) perspective diagram demonstrating a second arrangement of drone-robot pickup and delivery system arranged to safely and accurately accomplish door-to-door services of high-rise building complexes in accordance with another exemplary embodiment of the present invention;

FIG. 3A-FIG. 3B illustrate a smart drone-robot distribution kiosk in accordance with one exemplary embodiment of the present invention;

FIG. 4 illustrates a phase when the pickup and delivery robot arrives and/or at the elevator and uses its extendable robotic arm to operate the elevator of a high-rise building in accordance with an exemplary embodiment of the present invention;

FIG. 5 illustrates a phase when the pickup and delivery robot uses its robotic arm to select a floor inside the elevator of a high-rise building complex in accordance with an exemplary embodiment of the present invention;

FIG. 6 illustrates phase when the pickup and delivery robot autonomously moves along the hallway to and from the frontdoor inside a high-rise building in accordance with an exemplary embodiment of the present invention;

FIG. 7 illustrates a phase when the pickup and delivery robot arrives and/or leaves the destination in accordance with an exemplary embodiment of the present invention;

FIG. 8 shows the schematic diagram of the onboard computer of the pickup and delivery robot in accordance with an aspect of the present invention;

FIG. 9 shows the structure of the pickup and delivery robot in accordance with an aspect of the present invention;

FIG. 10 shows the drone-robot pickup and delivery network in accordance with an embodiment of the present invention

FIG. 11 illustrates the flow chart of the method of delivering postal packages by delivery drones from a predetermined safe landing site to the destination building of a high-rise building complex in accordance with an aspect of the present invention;

FIG. 12 shows the flow chart of the method of delivering postal packages by delivery robots to the frontdoor of customers who lives in a high-rise building complexes in accordance with an aspect of the present invention;

FIG. 13 illustrates the flow chart of the method of picking up of postal packages by pickup robots from the frontdoor of a customer to the kiosks of a high-rise building complex in accordance with an aspect of the present invention;

FIG. 14 shows the flow chart of the method of picking up postal packages by drones from a high-rise building complex to a central depot in accordance with an aspect of the present invention;

The figures depict various embodiments of the technology for the purposes of illustration only. A person of ordinary skill in the art will readily recognize from the following discussion that alternative embodiments of the structures and methods illustrated herein may be employed without departing from the principles of the technology described herein.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, and components have not been described in detail so as not to unnecessarily obscure aspects of the present invention.

Disclosed in the present specification is a novel postal service system including the combination of drones and robots that are programmed to safely and accurately pick up and deliver postal packages to the frontdoors of recipients who live in high-rise building complexes. This novel approach solves the long sought after problems and dangers likely to cause by balcony delivery drones.

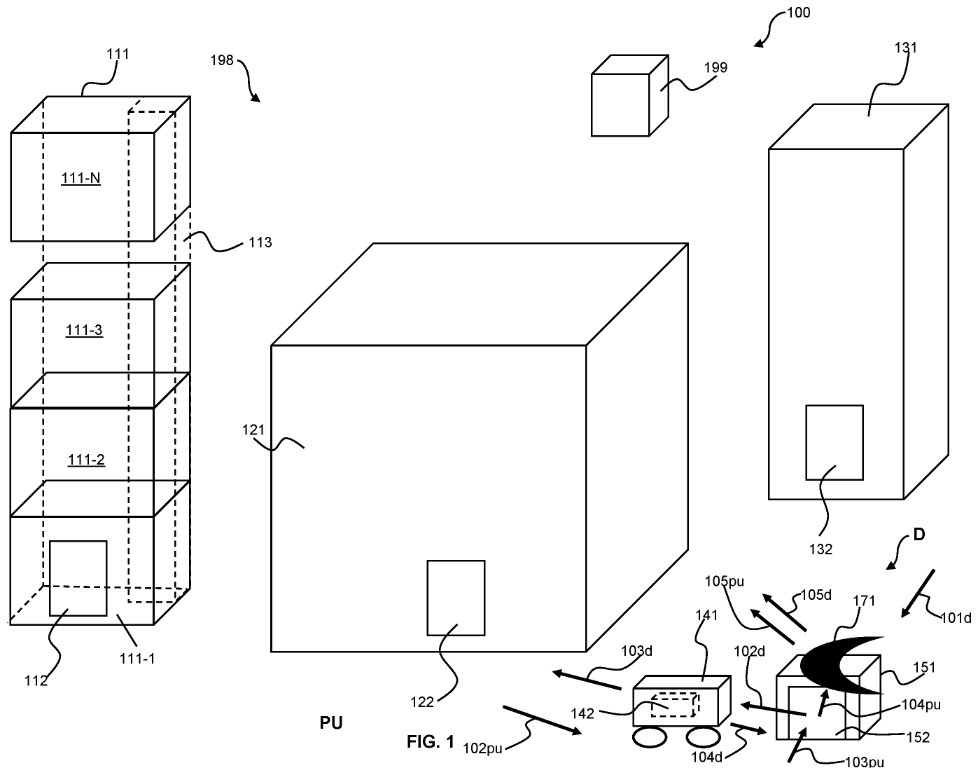

Now referring to FIG. 1, a 3 dimensional (3D) perspective diagram demonstrating a first arrangement of a drone-robot pickup and delivery system 100 (hereinafter referred to as “system 100”) configured to safely and accurately pick up and deliver postal packages and to-go foods to the frontdoors of residents who live in high-rise building complexes in accordance with an exemplary embodiment of the present invention is illustrated. In the present invention, the balcony delivery problems by drones are solved by using the combination of drone-robot system that provides door-to-door services that obviates the perils of the balcony delivery. An exemplary high-rise building complex 198 includes a first tower 111, a second tower 121, and a third tower 131. Each tower 111, 121, 131 has a plurality of floors and at least one entrance doors. First tower 111 has a front entrance 112, first floor 111-1, a second floor 111-2, a third floor 111-3, and an N^{th} floor 111-N, where N is a positive non-zero integer. In first tower 111, at least one elevators 113 are designed to transport the residents up and down. Similarly, second tower 121 has a front entrance 122 and third tower 131 has another front entrance 132. It is noted that first tower 111, second tower 121, and third tower 131 may have different number of floors, and structures which are serviced by different types of elevators. But for the sake of simplicity, they are all serviced by elevators similar to elevator 113. This exemplary high-rise building complex 198 has installed a distribution kiosk 151 for pickup and delivery drones 171 to land thereupon.

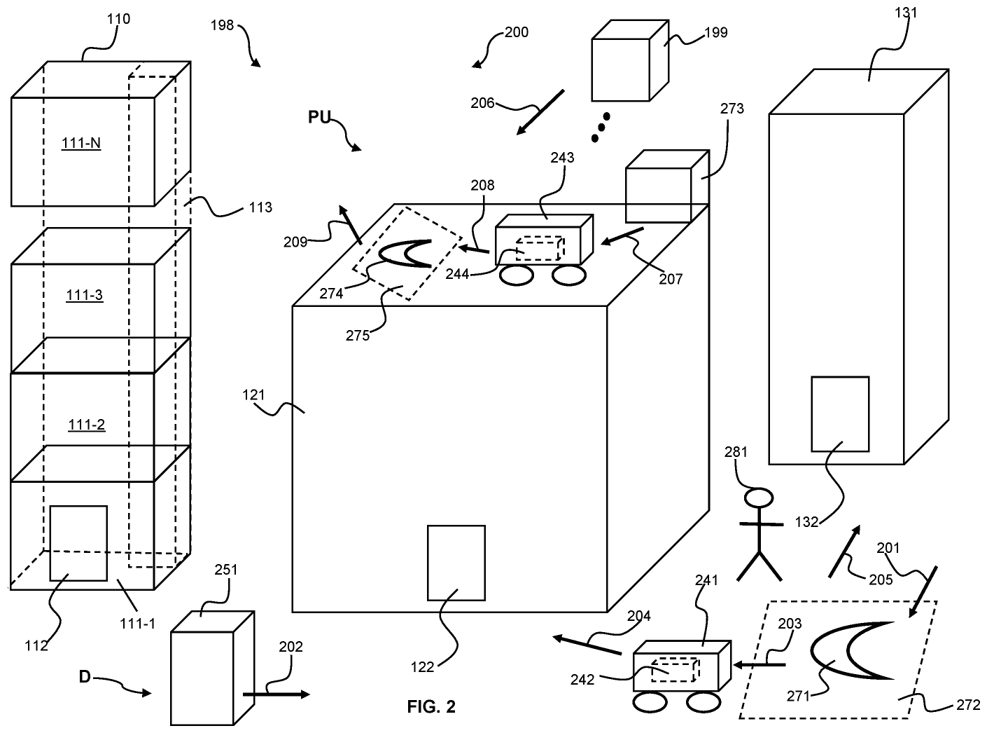

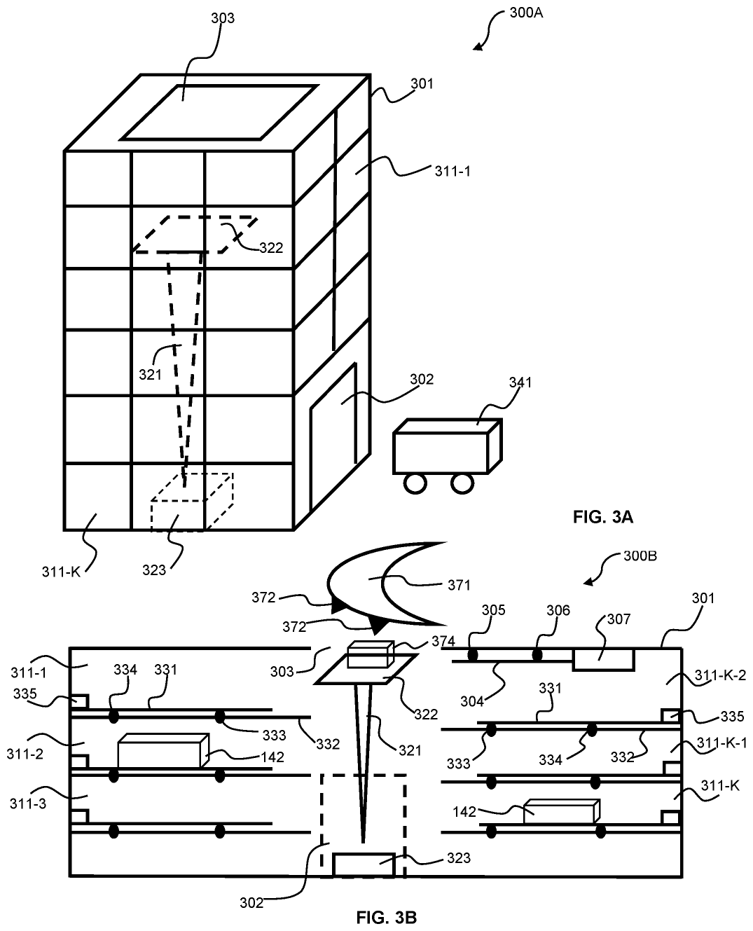

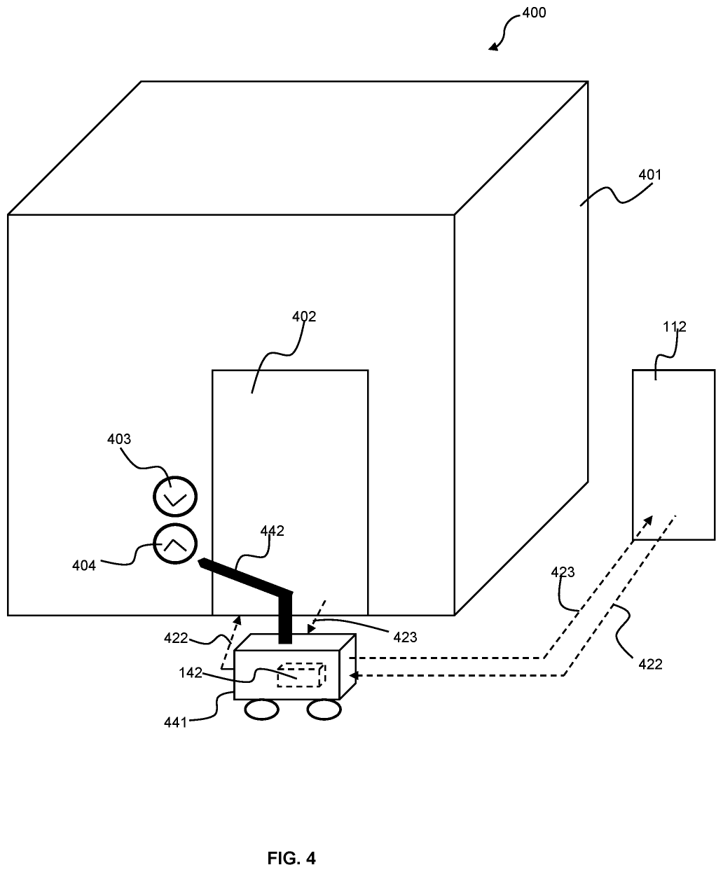

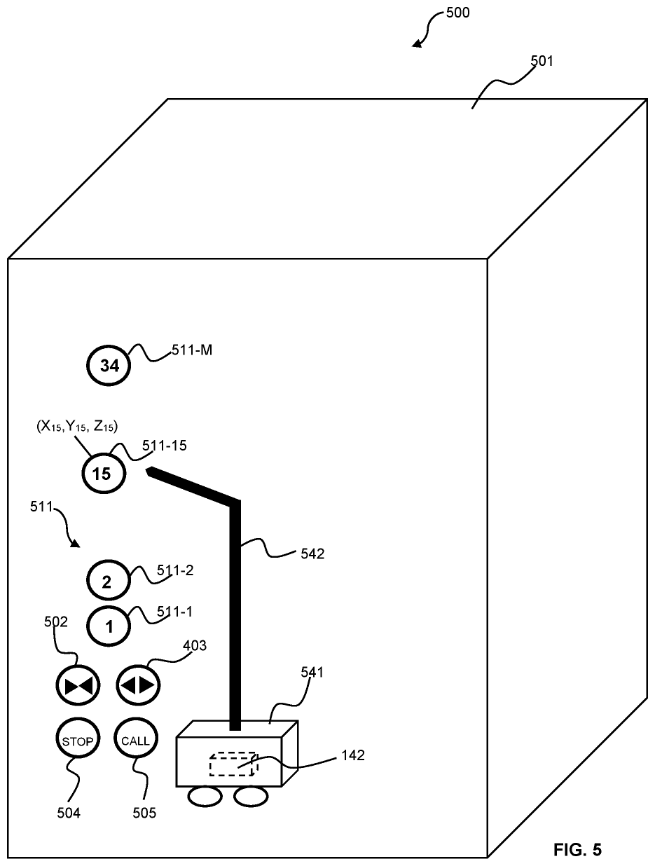

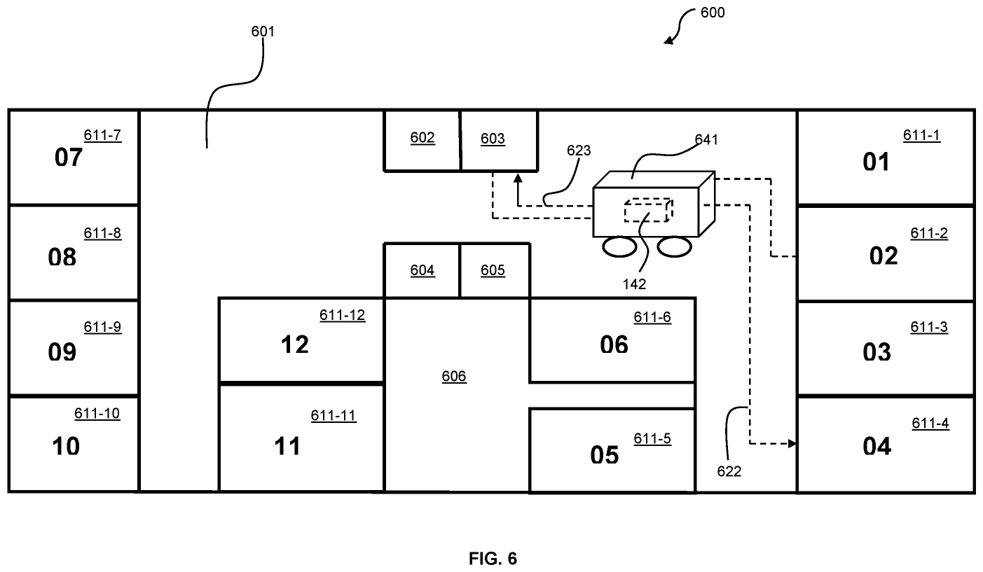

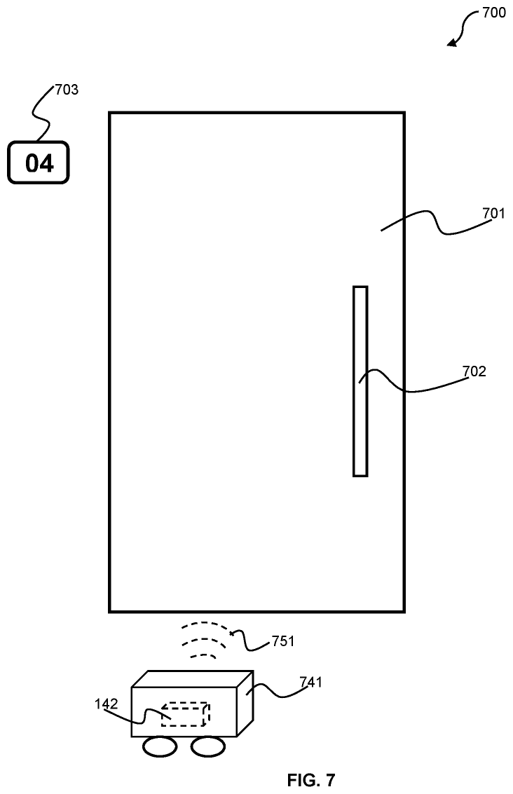

Continuing with FIG. 1, system 100 includes a delivery cycle D and a pickup cycle PU performed by the robots and drones combination of the present invention. Delivery cycle D and pickup cycle PU maybe arranged differently as shown in FIG. 2. It is noted that both arrangements provide fully automatic and convenient door-to-door services (pickup and delivery) to customers without the perils of balcony deliveries. Within the meaning of the present invention, delivery cycle D includes (1) at a step 101d: a drone 171 flies from a central depot 199 to land on top of distribution kiosk 151 and drone 171 drops off a postal package(s) 142 into distribution kiosk 151; (2) at a step 102d, distribution kiosk 151 transfers postal package(s) 142 to a robot 141, see FIG. 3 for more details; (3) at a step 103d, robot 141 drives itself to first tower 121 to deliver postal package(s) 142 to the frontdoors of recipients: (please see FIG. 4 to FIG. 7); and (4) at a step 104d, robot 171 returns to distribution kiosk 151 for more deliveries or for battery recharge; (5) at a step 105d, drone 171 returns to central depot 199. This completes D cycle. Pickup cycle PU includes (1) at a step 101pu, robot 141 go fetching postal package(s) 142 at the frontdoor of the customer: (see FIG. 7) and brings postal package(s) 142 to distribution kiosk 151: please see FIG. 6, FIG. 5, to FIG. 3; (2) at step 102pu, robot 141 moves toward distribution kiosk 151; (3) at a step 103pu, robot 141 enters an entrance 152 of distribution kiosk 151 to transfer postal package(s) 142 thereto, please see FIG. 3; enters distribution kiosk 151 via a door 152: step 105pu; (4) at a step 104pu, distribution kiosk 151 transfers postal package(s) 142 to drone 171, see FIG. 3; and finally, drone 171 flies back to central depot 199 for administrating, sorting, examining, and delivering later; this is step 105pu. This complete the pickup cycle PU and the delivery cycle D repeats.

Thus, system 100 described in FIG. 1 achieves the following objectives of the present invention:
(1) full and complete pickup and delivery services to the frontdoors of customers whereas the prior art systems only provide the drone delivery without pickup system;
(2) the long-felt but unmet demands for door-to-door postal services contemplated by drones balcony deliveries are solved; and
(3) full automation of pickup and delivery services is achieved.

Now referring to FIG. 2, a 3 dimensional (3D) perspective diagram demonstrating a second arrangement of a drone-robot pickup and delivery system 200 (hereinafter referred to as “system 200”) configured to safely and accurately deliver postal packages and to-go foods to the frontdoors of customers who live in high-rise building complexes in accordance with an exemplary embodiment of the present invention is illustrated. In the present invention, the balcony delivery problems by drones are solved by using the combination of drone-robot system that provides door-to-door services that avoids the perils of the balcony delivery. System 200 includes delivery cycle D and the pickup cycle PU. Delivery cycle D and pickup cycle PU maybe arranged in different locations as shown in FIG. 2. That is the delivery cycle D is arranged on the ground at a first predetermined safe landing site 272 (first landing site 272). Pickup cycle PU is arranged on a rooftop 198 of tower 121. Alternatively, delivery cycle D and pickup cycle PU may be in the same location either on the rooftop or on the ground areas. Within the meaning of the present invention, delivery cycle D includes (1) at a step 201, flying a delivery drone 271 that carries postal package(s) 242 from a central depot 199 to first landing site 272 of high-rise building complex 198; (2) at a step 202, moving a delivery robot 241 to meet up with delivery drone 271 at first landing site 272; (3) a step 203, transferring postal package(s) 242 to a delivery robot 141; (4) at a step 204, delivery robot 241 delivers postal package(s) 242 to the frontdoors of the recipients (see FIG. 4 to FIG. 7); and (5) at a step 205, delivery drone 271 returns to central depot 199. Pickup cycle PU includes (1) at a step 207, picking up postal package(s) 244 to be delivered at the frontdoor of the customers and moving toward a second predetermined landing site 275 (see FIG. 4 to FIG. 7); (2) at step 208, transferring pickup postal package(s) 244 to pickup drone 274 at second landing site 275; and (3) at step 209, flying pickup drone 274 back to central depot 199 for administrating, sorting, examining, and delivering later.

Still referring to FIG. 2, in step 201, delivery drone 241 departs from central depot 199 with package 242 and arrives at first landing site 272 inside high-rise building complex 198. As delivery drone 241 lands on first landing site 272, a delivery robot 241 leaves a docking station 251 following step 202 to meet up with delivery drone 271. At step 203, delivery robot 241 receives postal package(s) 242 to be delivered to the frontdoors of different customers who live in various locations such as floors 111-1, 111-2, 111-N inside first tower 110. Still in step 203, delivery robot 241 is also loaded with delivery addresses and a pre-programed return trajectories. In many aspects of the present invention, during step 203, delivery postal package(s) 242 may be transferred between delivery drone 271 and delivery robot 241 by humans such as postal service agents 281 working in high-rise building complex 198. More particularly, during step 203, postal service agents 281 open delivery drone 271, takes out and scan each delivery postal package(s) 242 and load them to delivery robot 241. It is noted that other package transferring methods from delivery drone 171 to delivery robot 241 such as robotic arms, robots-drone docking mechanism, or other fully automatic transfer without human assistances such as distribution kiosk 151, etc., are within the scope of the present invention. After delivery drone 271 is completely unloaded, delivery robot 241 begins its delivery mission in step 204. See FIG. 4-FIG. 7. At the same time, delivery drone 271 flies back to central depot 199 located faraway in step 205.

Still referring to FIG. 2, in pickup cycle PU, after a customer has placed an order for pickup, central depot 199 scans in all pickup information and sends a pickup drone 274 to high-rise building complex 198 in step 206. From a docking station 273, pickup robot 243 is sent to pick up pickup postal package(s) 244 at the frontdoors of the customers. See FIG. 4-FIG. 7. As pickup robot 243 arrives at the frontdoors of the customers (see FIG. 4-FIG. 7), it mades a phone call to the customer. The customer comes out with pickup postal package(s) 244. The customer places pickup postal package(s) 244 inside pickup robot 243. Pickup robot 243 returns to docking station 273. Along step 207, pickup robot 243 carrying a pickup postal package(s) 244 exits docking station 273 moving toward second landing site 275. In a step 208, pickup postal package(s) 144 is transferred to pickup drone 274 in the same manner as that in step 203 described above. After step 208 is completed, in a step 209, pickup drone 274 flies back to central depot 199. Afterward, delivery cycle D repeats. The details and requirements of delivery cycle D and pickup cycle PU by the combinations of delivery drones 171, pickup drone 274, delivery robot 241, and pickup robot 243 will be disclosed in FIG. 3 to FIG. 14.

Now referring to FIG. 3A, a 3D diagram of a drone-robot distribution kiosk 300A (distribution kiosk 300A) in accordance with an exemplary embodiment of the present invention is illustrated. Distribution kiosk 300A is part of system 100 which is installed in high-rise building complex 198. Distribution kiosk 300A includes a storage house 301 having an entrance 302 designated for robot 341 to pick up and deliver postal package(s) 142. Storage house 301 includes an opening 303 formed on the topside. Opening 303 is designed for a drone 171 to pick up and deliver postal packages 142. Storage house 301 also includes different slot boxes 311-311-K designed to store postal package(s) 142. A robotic arm 321 with a support 322 are designed to move postal packages 142 in and out of slot boxes 311-1 to 311-K. Robotic arm 321 is serviced by a computer 323. Computer 323 is programmed to move robotic arm 321 to exact locations of slot boxes 311-1 to 311-K.

Referring to FIG. 3B, a 2D layout of a drone-robot distribution kiosk 300B (distribution kiosk 300B) in accordance with an exemplary embodiment of the present invention is illustrated. On the top side of storage house 301, a sliding cover 304 is coupled to a system of wheels 305-306 and next to opening 303. Sliding door 304 is designed to close up opening 303 when distribution kiosk 300B is not in use. Inside each slot boxes 311-1 to 311-K, there are a pair of wheels 333 and 334 coupled to a slot box platform 332 that slides a slider 331 in and out to meet with support 322. DC brushless motors 335, controlled by computer 323, operate pair of wheels 333 and 334 and sliders 331. In delivery D cycle, robot 341 drives itself inside storage house 301 via door 302. Following the instructions of computer 323, robotic arm 321 moves to transfer postal package(s) 142 to support 322. Then robotic arm 321 moves to deposit postal package(s) 142 to an available slot box 311-1 to 311-K. Slider 331 is slided out by motor 335 to transfer postal package(s) 142 to the interior of one of slot boxes 311-1 to 311-K. Robot 341 is ordered to leave storage house 301 via door 302. Inside, robotic arm 321 goes to slot box 311-1 to 311-K that contains the just-delivered postal package(s) 142. Slider 331 is slided out to transfer postal package(s) 142 to support platform 322. Next, robotic arm 321 moves to opening 303 so that drone 171 with a pair of grippers 372 grasps postal package(s) 142. Finally, drone 171 flies back to central depot 199 for further administrating tasks. In the case when drone 171 has already been there when robot 341 arrives, robotic arm 321 moves postal package(s) 142 directly to drone 171 without depositing to slot boxes 311-1 to 311-K.

Still referring to FIG. 3A-FIG. 3B, the mechanical structure as disclosed above including storage house 301, door 302, opening 303, slot boxes 311-1 to 311-K arranged in 3D matrix structure, robotic arm 321, support platform 322, cover 304, system of wheels 305-306, pair of wheels 333 and 334, DC motors 335 is sufficient to enable a person of ordinary skills in the mechanical art to build distribution kiosk 300A without undue experiment. In various embodiments of the present invention, computer 323 that operates distribution kiosk 300 includes non-transitory programming codes that implemented steps described above using Arduino UNO system. UNO system also includes IR sensors placed inside storage house 301.

Next referring to FIG. 4, a 3D perspective diagram 400 demonstrating a phase when a pickup and delivery robot uses an extendable robotic arm to open the door of an elevator of the high-rise building complex in accordance with an exemplary embodiment of the present invention is shown. In this phase, after entering main entrance 112 of first tower 110, a pickup and delivery robot 441 (robot 441) moves toward an elevator 401 having a door 402, a down button 403, and an up button 404 along a trajectory 422. As the delivery information for each postal package 142 is scanned in by postal service agents 281, robot 441 is programmed to deliver and picks up postal package(s) 142 to and from different customers. In accomplishing this task, robot 441 operates elevator 401 in full automation. In many preferred embodiments of the present invention, robot 441 is equipped with a robotic arm 442 controlled by deep learning algorithms and/or recurrent convolutional neural network (R-CNN). After reading the signs and words on elevator 401 such as “open”, “close”, up (“\hat{ }”), or down (“v”) or the equivalents in other languages such as French, Chinese, Japanese, or Vietnamese, a neural network algorithms such as RCNN in connection with a mechanical controller orders robotic arm 442 what buttons to select. The detailed operation of robot 441 with robotic arm 442 to operate elevator 401 without assistance will be provided in FIG. 5-FIG. 10 below. Yet in some other embodiments, elevator 401 and robot 441 can communicate wirelessly via a communication module. An example of this automatic elevator operation is done by KONE Elevator. However, this embodiment requires the substitution of all pre-existing elevators, which is costly. Alternatively, in another embodiment of the present invention, an electronic control box is designed and attached to the controller of pre-existing elevators. This electronic control box enables robot 441 to communicate with and to control elevator 401. Yet in another embodiment of the present invention, postal service agents 281 can assist robot 441 to operate elevator 401 by accompanying it to each destination floor and frontdoor. However, in preferred embodiments of the present invention, robot 441 uses robotic arm 442 to operate elevator 401 by itself in full automation. In system 100, after finishing the deliveries along trajectory 422, robot 441 uses the same operations to return to distribution kiosk 151 (described in 300A and 300B) via a return trajectory 423. In system 200, robot 441 returns to docking station 251.

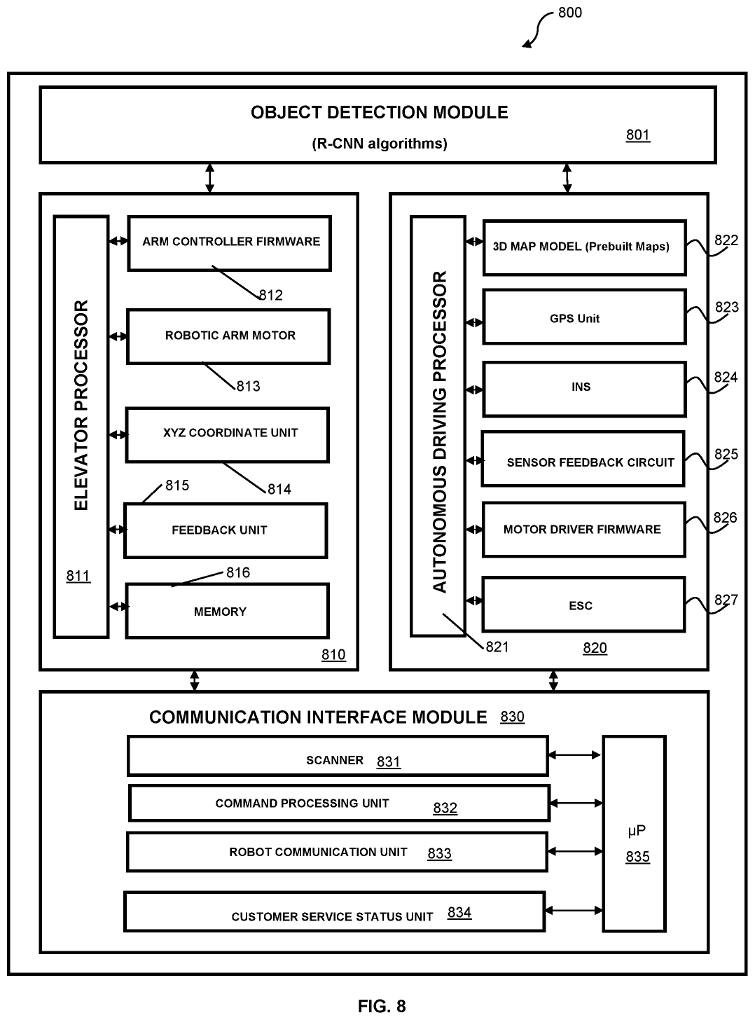

Next referring to FIG. 5, a perspective diagram demonstrating a phase 500 when the pickup and delivery robot operates the elevator in accordance with an exemplary embodiment of the present invention is illustrated. After a pickup and delivery robot 541 (robot 541) has entered an elevator 501, using computer vision, deep learning, or recurrent convolutional neural network (RCNN) algorithms, robot 541 reads elevator operation panel 511 that includes a door close button 502, a door open button 503, emergency stop button 504, and an emergency call button 505. Emergency stop button 504 is pressed when a customer is ill or claustrophobic and needs to get out. Call button 505 is pressed when elevator 501 malfunctions. Robot 321 is trained by deep learning algorithms to detect and locate different buttons. More specifically, elevator operation panel 511 includes a first floor button 511-1, a second floor button 511-2, a third floor button 511-3, and . . . N^{th} floor button 511-N. In an exemplary and non-limiting situation in FIG. 5, N is 34. Robot 541 detects and locate the coordinates of elevator operation panel 511 to select a floor where it is programmed to deliver postal package(s) 142. Robot 541 then extends robotic arm 542 to press the button whose (x,y,z) coordinate has been determined (please refer to FIG. 8). In a particular and non-limiting example in FIG. 5, the selected floor is 15 (floor 511-15) having coordinates (X₁₅, Y₁₅, Z₁₅). The object detection and localization algorithms used for this purpose is built from github, CoCo dataset, TensorRT to build the RCNN model and Open Neural Network Exchange (ONNX), and TensorRT optimizer.

Next referring to FIG. 6, a perspective diagram demonstrating a fourth phase 600 when the delivery robot autonomously moves along the hallway to the frontdoor of a recipient inside the high-rise building complex in accordance with an exemplary embodiment of the present invention is illustrated. When a pickup and delivery robot 641 (robot 641) is commissioned to provide pickup and delivering services at high-rise building complex 198 of FIG. 1, it is loaded with the floor maps and the GPS coordinates of each room for each floor 111-1, 111-2, 111-3 to 111-N (where N equals 34) in each tower 110, 121, and 131. Alternatively, in other embodiments of the presentation, a 3-dimension (3D) model of each floor stitched with coordinates (x,y,z) of each room is loaded into each robot 641. As a non-limiting example, on the 15^{th} floor, a group of four elevators 602, 603, 604, and 605 arranged as shown are designed to serve first tower 110. A hallway 601 leads to room 611-1, 611-2, 611-3, 611-4, 611-5, and 611-6 on the right hand side. On the left hand side, hallway 601 leads to room 611-7, 611-8, 611-9, 611-10, 611-1, and 611-2. Electrical, internet connections, and other utility rooms 606 are behind elevators 602, 603, 604, and 605 on the 15^{th} floor. As robot 641 exits of elevator 603, it autonomously follows a delivery trajectory 622 that has been loaded from drone 171. Please refer back to FIG. 1. After the delivery on the 15^{th} floor is finished, robot 641 either returns back to distribution kiosk 151 or docking station 251 or to different floors for more deliveries using a return trajectory 623.

Next referring to FIG. 7, a perspective diagram demonstrating a phase 700 when the pickup and delivery robot arrives at the frontdoor of a recipient in accordance with an exemplary embodiment of the present invention is illustrated. In many preferred embodiments of the present invention, as a pickup and delivery robot 741 (robot 741) arrives at the destination which is represented by a frontdoor 701 with a handle 702 and a room number sign 703, robot 741 calls the customer via a wireless telephone signal 751 (“call 751”). The customer comes out to receive delivery postal package 142. In situation when the customer is not home and call 751 is unanswered, robot 751 drops off or pick up package 142 at frontdoor 701. After delivery or pickup is completed, robot 751 reports the pickup or delivery status to central depot 199. The pickup and delivery status will be either (a) by owner, or (b) by robot 741. If the delivery is made by robot 751 (i.e., the customer is not home), central depot 199 will call the owner to inform about the pickup and delivery status. The delivery made by robot (in case the customer is unavailable) is realized by either (1) mechanical structure built in to robot 741 or (2) by postal service agents 281.

FIG. 8-FIG. 10 disclose the mechanical and electrical structure of robots 141, 241, 274, 341, 441, 541, 641, and 741. The reasons these robots of the present invention have different reference numbers because they are in different phases of the delivery and pickup cycles. The mechanical and electrical structures disclosed hereinafter enable robots of the present invention to perform the tasks described above.

Now referring to FIG. 8, a schematic diagram of a robot system controller 800 of the pickup and delivery robot (robot system controller 800) in accordance with an aspect of the present invention is illustrated. Pickup and delivery robots 141, 241, 274, 341, 441, 541, 641, and 741 are autonomous mobile robots (AMR) capable of path planning, motion control, safety control, broad field sensing, vision and autonomous navigation. These AMRs are invented to cooperate with drone 171, delivery drones 271 and pickup drone 274 for respective delivering and picking up of postal packages 142 at frontdoor 701 of the customers who live in high-rise building complex 198. In various preferred embodiments of the present invention, the drone-robot cooperation is realized by distribution kiosk 151 described in system 100 in FIG. 1 and FIG. 3A-FIG. 3B. In other embodiments, the drone-robot cooperation is realized by postal service agents 281 or by other automation methods described in FIG. 2. In addition, pickup and delivery robots of the present invention are invented to operate elevator system 113 without the assistance of the humans. In many preferred embodiments of the present invention, pickup and delivery robots 141, 241, 274, 341, 441, 541, 641, and 741 use robotic arm 212 to fully operate elevator system 113 without the assistances of humans. In other embodiments of the present invention, pickup and delivery robots 141, 241, 274, 341, 441, 541, 641, and 741 operate elevator system 113 by wireless communication with (a) smart elevators that can communicate with robots, (b) pre-existing elevators that are modified by equipping with a communication module to communicate with delivery robots. Yet in other embodiments of the present invention, pickup and delivery robots 141, 241, 274, 341, 441, 541, 641, and 741 are assisted by humans (such as postal service agents 281 or a runner whose job is to handle the cooperations between drone-robot) to handle delivery postal package(s) 142 and pickup postal package(s) 144 and to operate elevator system 113.

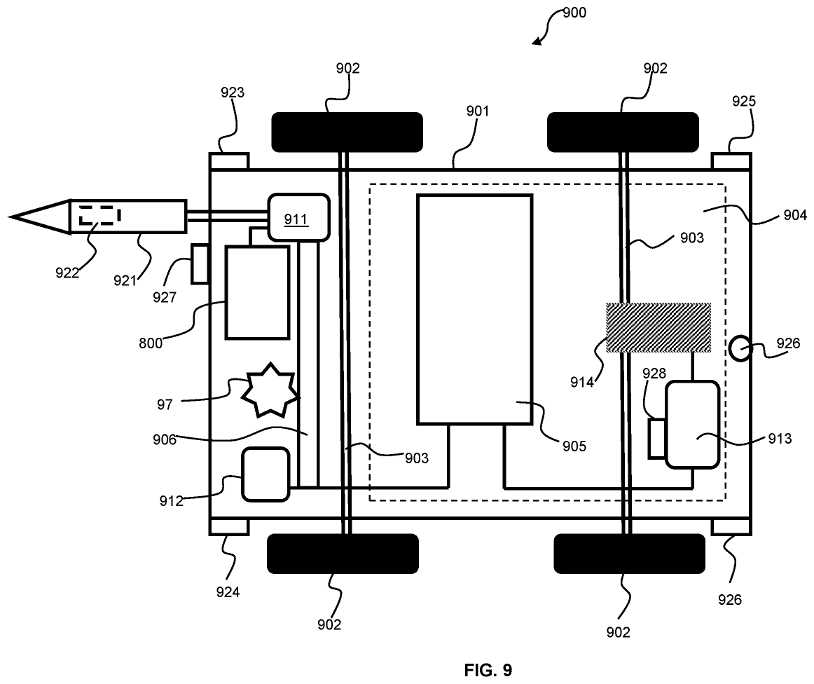

Referring again to FIG. 8, robot system controller 800 includes an object detection and localization module 801, an elevator module 810, an autonomous driving module 820, and a communication interface module 630. Object detection and localization module 601 includes cameras (not shown, please refer to FIG. 9) and artificial intelligence based (AI-based) software programs that detects and locates the objects such as signs 603, 604; elevator operation panel 511; door close button 502, door open button 503, emergency stop button 504; and call button 505. Cameras or sensors (not shown, see FIG. 9) and AI-based object detection and localization software are readily available from the libraries of open source software from ONNX which includes TensoRT optimizer, ONNX, Jetson NX, LaSOT model tracking which are built on Pytorch model. The dataset used is a CoCo dataset which included 1,500 trained images and 500 test images of signs 203, 204; elevator operation panel 511; door close button 502, door open button 503, emergency stop button 504; and call button 505, etc. An example of object detection and localization algorithms are recurrent convolutional neural network (RCNN), faster RCNN, sparse RCNN, single shot multibox detector (SSD), or You Only Look Once (YOLO). Other object recognition and localization algorithms used in elevator module 810 is a central processing unit (CPU) or graphic processing unit (GPU) from Intel, Nvidia, or Amdahl designed to receive decision from the images seen by high definition RGB cameras.

Continuing with FIG. 8, object detection and localization module 801 enables elevator module 810 fully operates elevator system 113 without human assistance. Elevator module 810 includes an elevator processessing unit 811, an arm controller firmware 812, robot arm motor 813, an XYZ coordinate unit 814, and feedback unit 815. In term of hardware, elevator processing unit 811 is a processor that controls robotic arm 442 (or robotic arm 542) using arm controller firmware 812 and robot arm motor 813 with respect to XYZ coordinate unit 814 and feedback unit 815. Robotic arm 442 (or robotic arm 542) is designed and assembled to imitate a human arm when operating elevator system 113. In many embodiments of the present invention, robotic arm 442 is a commercially available gripping robot arms that are modified and redesigned either by software and/or hardware. Robotic arm controller firmware 812 used in the present is EEZYbotarm Arduino firmware.

Continuing with FIG. 8, autonomous driving module 820 is similar to that in an autonomous driving car that relies on a sensor feedback circuit 825 LiDAR (Light Detection and Ranging) a 3D map model 822, a GPS unit 823, an inertia navigation system (INS) 824, a sensor feedback circuit 825, motor driver 826, and an electronic speed control (ESC) 824. All are processed by an autonomous driving processor 821. 3D map model 822 is a 3D model of each floor 111-1, 111-2, to 111-N where each room 611-1, 611-2, to 611-12 is stitched with GPS coordinates. In other words, 3D map model 822 is similar to 2D floor map 601 but it is extended in 3D. 3D model can be obtained from ArcGIS (Aeronautical Reconnaissance Coverage Geographic Information System) by Esri's 3D mapping software with each room location stitched with GPS or XYZ coordinates. 3D map model 822 is loaded into robots 141, 241, 243, 341, 441, 541, 641, and 741 when it is commissioned to serve high-rise building complex 198 such as one described in FIG. 1. When robot 141 and 241 are loaded with the delivery address, autonomous driving processor 821 and object detection and localization module 801 form trajectories 422, 423, 622, and 623. This map—including trajectory 422, trajectory 423, trajectory 622, and trajectory 623—is loaded into 3D map model 822. With this map, motor driver 826 causes robot 141 or robot 241/243 to move autonomously to destination 611-4. Sensor feedback circuit 825 helps autonomous driving processor 821 and object detection and localization module 801 to calculate and plan the map that avoids collisions with passerbys, other robots, and/or animals, achieving safe and autonomous navigation. Autonomous driving module 620 creates and maintain a floor map of their surroundings based on a variety of sensors situated in different parts of the vehicle (see FIG. 9). Radar sensors monitor the position of nearby robots and/or passerbys. Sensors may include video cameras designed to detect elevator operation panel 511, track other robots, and look out for passerbys. Lidar (light detection and ranging) sensors bounce pulses of light off floor map 601 and surroundings to measure distances, detect road edges, and identify lane markings. Sensors associated with sensor feedback circuit 825 may include ultrasonic sensors that can detect other robots, passerbys, walls, animals, and/or other obstacles. Sophisticated software such as Ardupilot then processes all sensory inputs, plots, trajectories 422 or 423, and sends instructions to sensor feedback circuit 825, motor driver firmware 826, ESC 827 which control the acceleration, braking, and steering of robot 171 or robot 274. Hard-coded rules, obstacle avoidance algorithms, predictive modeling, and object recognition help the Ardupilot software follow traffic rules and navigate obstacles.

Continuing again with FIG. 8, communication interface module 630 is mainly a transceiver that includes a scanner 831, a command processing unit 832, a robot communication unit 833, a customer delivery status unit 834, and a microprocessor 835. Scanner 831 is a sensor designed to import delivery or pickup information that includes (i) room number (i.e. 611-4) that is supposed to deliver to the frontdoor of room number (611-4), floor number (111-15), and package ID number. In some embodiments of the present invention, scanner 831 can be RFID code, QR codes, bar codes, or any other type of ID codes. Drone 171 sends the pickup and delivery information to robot 221 after it lands on top of distribution kiosk 151 (see FIG. 1, FIG. 3A and FIG. 3B) or in predetermined landing site 272. Delivery or pickup information is a command that includes (1) start bits, (2) address frame, (3) acknowledge bits, (4) first data frame, (5) second acknowledge bits, (6) data frame, and (7) stop bits. First data frame and second data frame include (i) room number (i.e. 611-4) that is supposed to deliver to the frontdoor of room number (611-4), floor number (111-15), and package ID number, all encoded in form of either barcodes or Qcodes. As mentioned before, postal service agents 281 scans package 142 to robot 171. Drone command processing unit 832 is a processor that processes delivery information for each package 142. It is noted again that robot 171 can deliver multiple packages to different customers in one delivery tour. That is, drone command processor unit 832 detects the delivery or pickup information and counts of the total number of packages to delivery, addresses, and floor numbers. Then, microprocessor 835 plans out an optimal route that requires the least number of going and leaving a floor. In addition, microprocessor 835 keeps track of the pick-up and delivery steps described above in FIG. 1-FIG. 7. Robot communication unit 833 is a transceiver that sends and receives pickup and delivery status to and from central depot 199. Customer service status unit 834 receives the pickup and delivery statuses from a microprocessor 835 and reports to central depot 199.

FIG. 1 to FIG. 8, the drone and robot combination achieves the following objectives of the present invention:
(1) solutions for the long felt but unmet demands for balcony delivering by drones;
(2) easy to set up and operate;
(3) minimal human interlopers;
(4) door-to-door service convenient to customers without the perils of balcony deliveries by drones; and
(5) full service including door-to-door pickups and deliveries realized by the combination of drone-robot.

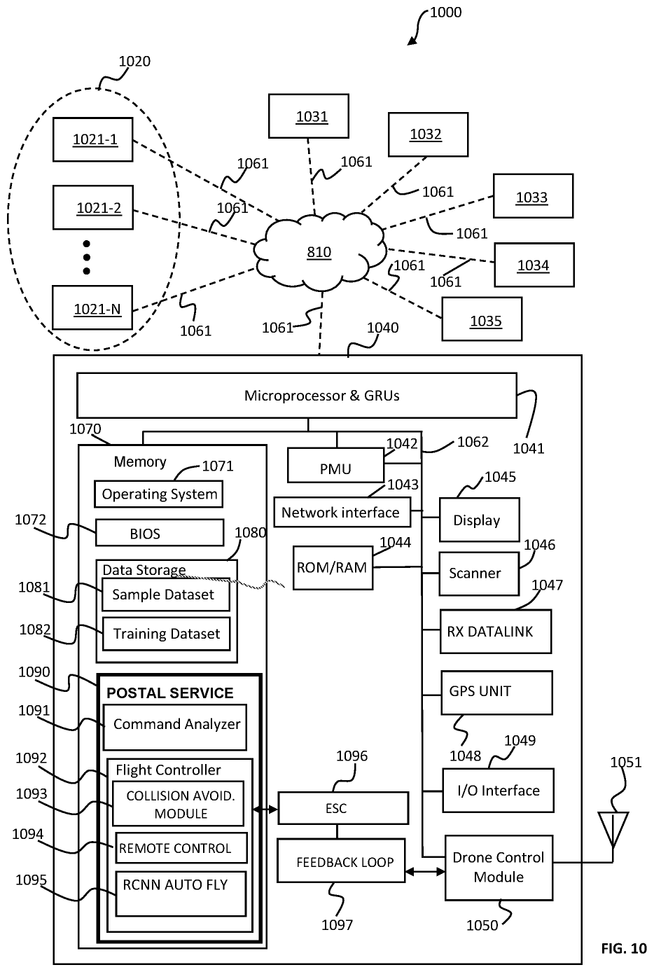

FIG. 9 to FIG. 10 disclose the details that enable the full service including door-to-door pickups and deliveries realized by the combination of drone-robot described above.

Now referring to FIG. 9, a 2D bottom view of a pickup and delivery robot 900 (robot 900) capable of operating any elevators and traveling by itself in accordance with an exemplary embodiment of the present invention is illustrated. Robot 900 includes a chassis 901; four wheels 902 connected together by respective axels 903; a storage space 904 on top for storing postal packages 142; a Lithium battery 905; a linear slide rack 906, a pinion 907; a spur gear 914, DC motors 911, 912, and 913; a robotic arm 921 electrically and mechanically coupled to DC motor 911; and robot system controller 900 described in FIG. 8. A front camera 922 mounted on top of robotic arm 921 for viewing and detecting elevator operation panel 511. In addition, robot 900 includes sensors 923, 924, 925, and 926; a rear camera 926; an inertia navigation system (INS) 927 for direction finding and an electronic speed controller (ESC) 928. In operation, when delivery postal package(s) 142 or pickup postal package(s) 144 is scanned in and transferred to robot 241 or robot 244 respectively by postal service agents 281 using scanner 831. The pickup and delivery information is decoded by command processing unit 832. Then microprocessor 835 uploads a predetermined service steps such as steps (D cycle: 102d-104d or 202-204; PU cycle: 101pu-103pu and 207-208) and trajectories (422, 423, 622, 623) associated with GPS unit 823 into autonomous driving processor 821, 3D map model 822, and elevator processessing module 801. Autonomous driving processor 621 executes the results of object detection and localization module 601. Front camera 922, rear camera 926, sensors 923-926, INS 927 for direction finding and ESC 928 send feedback and visual image signals to autonomous driving processor 821. Robot 700 can self-drive (auto pilot) along steps (D cycle: 102d-104d or 202-204; PU cycle: 101pu-103pu and 207-208) and trajectories (422, 423, 622, 623) without collisions, misdirection's, accidents, and incorrect pickups and deliveries. As robot 900 arrives at elevator door 402 of elevator 401. Front camera 922 sees and detects down sign 403 and up sign 404. Object detection and localization module 801 recognizes down sign 403 and upside 404 using the RCNN algorithms stored inside object detection and localization module 801. 3D map model unit 822, feedback unit 815, XYZ coordinate unit 814, and GPS unit 823 determine the coordinate locations (XᵢYᵢZᵢ) of up sign 403 and down size 404. Robot 900 approaches elevator door 402 and uses robotic arm 921 to correctly press either up sign 403 or down sign 404. 3D map model unit 822. This is possible because feedback unit 815, XYZ coordinate unit 814, and GPS unit 823 determine the exact coordinates of up sign 403 and down size 404. Up sign 403 is detected and selected because robot 900 knows its coordinates (XᵢYᵢZᵢ). The same process is repeated after robot 900 is inside elevator as shown in FIG. 5. Images and coordinate locations of each button of elevator operation panel 511 are detected by the joint operations of object detection and localization module 801, XYZ coordinate unit 814, feedback unit 815, and GPS unit 823. Then robot arm motor 813 starts to select a particular button such as 15^{th} floor button 511-15 whose coordinate is (X₁₅, Y₁₅, Z₁₅). Robot 900 records this phase into memory unit 616. When requested, robot communication unit 833 retrieves this information from memory unit 816 and transmits to central depot 199.

Still continuing with FIG. 9 and referring back to FIG. 6, as robot 900 leaves elevator 603, it moves autonomously to the frontdoor of room 04 611-4 of the customer. During this phase, trajectories 622 and 623 has been loaded into autonomous driving processor 821 which executes the RCNN algorithms of object detection and localization module 801 to drive along trajectories 622 and 623 to frontdoor of room 611-4. At the frontdoor of room 611-4, robot 900 calls the customer using robot communication unit 833. Afterward, robot 900 drives back to elevator 603 along trajectory 623. Please refer to FIG. 6. Along trajectories 622 and 623, sensors 923-926 and rear camera 926 are operated to input image signals to sensor feedback circuit 825. Sensor feedback circuit 825 converts and filters these input image signals. Then sensor feedback circuit 825 feeds the feedback signals to autonomous driving processor 621. The RCNN algorithms adjust the driving of robot 700 to avoid collision and to drive along trajectories 422 and 423. Referring back to FIG. 3 and FIG. 4, once inside elevator 403 on the way to other pickup and/or deliveries or to kiosk 151 or kiosk 173, the process inside elevator described in FIG. 3 repeats. Robot 900 detects elevator operation panel 511, selects a floor 311-1 to 311-M using robotic arm 721 and front camera 722. In various embodiments of the present invention, sensors 923-926 are either ultrasonic radars, millimeter radars, infrared camera, or 16-line Lidar. As disclosed above, robot 900 also includes INS 927 for direction finding and ESC 827. Memory unit 816 stores image data of elevator operation panel 511, each resident front doors 611-1 to 611-M, elevator front doors 112, 122, 132, and 602-605, and predetermined steps (D cycle: 102d-104d or 202-204; PU cycle: 101pu-103pu and 207-208) and trajectories (422, 423, 622, 623). In the present invention, each robot 900 is commissioned to serve a specific tower (i.e., 110, 121, or 131) in specific high-rise building complex 198 and in different countries. The size of dataset used for objection detection depends on each building (tower) robot 900 is intended to serve. Typically, the dataset consists of 2,000 images ranging in size of 167×168 pixels for each service location.

Next referring to FIG. 10, a perspective diagram showing the macroscopic view of a drone-robot electronic system 1000 designed to pick up and deliver to and from the central depots to the frontdoors of customers (system 1000) in accordance with an embodiment of the present invention is illustrated. In essence, system 1000 includes a group of central depots 831 to 835 and high-rise building complexes 1021-1, 1021-2, . . . , 1021-N. High-rise building complexes 1021-1, 1021-2, . . . , 1021-N are grouped together in an area 1020. Each high-rise building complexes 1021-1, 1021-2, . . . , 1021-N is similar to high-rise building complex 198. Central depots 1031 to 1035 are command & control center (C³) in charge of collecting all postal packages for administrating, controlling, and monitoring the entire postal services. In other words, central depots 1031 to 1035 are the brain of the postal services in that area 1020. Geographically, central depots 1031 to 1035 are located sufficiently far away from one another and from area 1020. A drone onboard computer 1040 is mounted on a drone (such as 171, 271, or 274) or unmanned aerial vehicle (UVA), aircraft, or the likes. In various preferred embodiments, drones 171 or 174 are the Hera© drone described in detailed in a patent application entitled, “Method for Destroying the Enemy's Targets Using Missiles Launched from Drones Carried Inside Soldiers' Packbacks”, filed on Jul. 17, 2022, application Ser. No. 17/813,042, by the same inventor Quoc Viet Luong. System 1000 also includes a network 1010 that connects onboard computer 1040, high-rise building complexes 1021-1, 1021-2, . . . , 1021-N in area 1020, and central depots 1031 to 1035 via communication links 1061. In various embodiments of the present invention, communication links 1061 may include, but not limited to, long range wireless communication channels including UHF/VHF radio frequencies or cellular network, e.g., GSM, GPRS, WCDMA, HSPA, 4G, 5G, and LTE, etc.

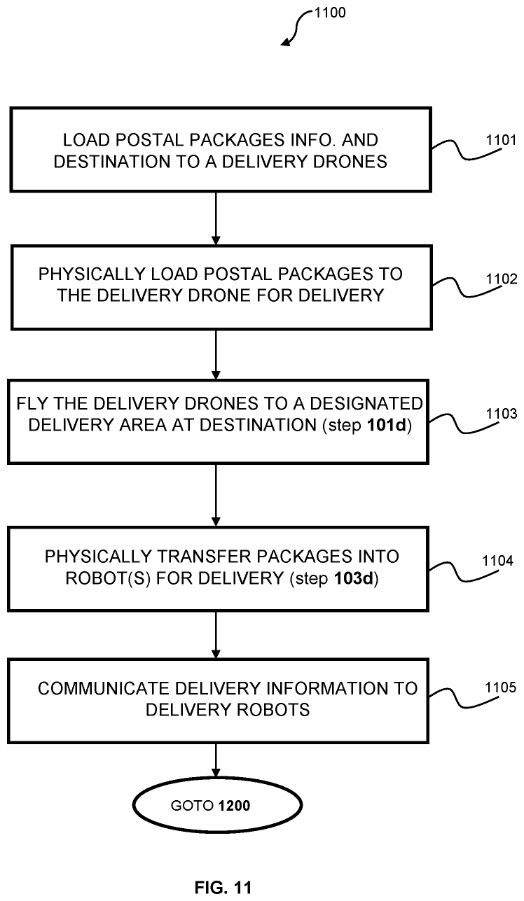

Continuing with FIG. 10, onboard computer 1040 includes a power management unit 1042, a network interface 1043, a Read Only Memory (ROM), Random Access Memory (RAM) 1044, a display 1045, a scanner 1046, a RX datalink 1047, a GPS unit 1048, input/output interface 1049, and a drone control module 1050. Power management unit 1042 provides and manages necessary power supplies to drone onboard computer 1040. Memory 1070 stores Basic input/output system (BIOS) 1072 for controlling low-level operation of onboard computer 1040. Memory 1070 also stores an operating system (OS) 871 for controlling the operations of onboard computer 1040. Data storage 1080 illustrates example of non-transitory computer-readable storage media as well as computer-readable instructions, data structures, program modules or other data for storage of virtual nodes and infrastructure of system 1000. It will be appreciated that operating system (OS) 1071 and Basic input/output system (BIOS) 1072 may include but not limit to a general-purpose operating system such as a version of UNIX, Python, Java, or LINUX™, or a specialized operating system such as Microsoft Corporation's Windows® operating system, or the Apple Corporation's IOS® operating system. The operating system (OS) 1071 may include, or interface with a Java virtual machine module that enables control of hardware components and/or operating system operations via Java application programs. Onboard computer 1040 also includes a postal service module 1090 which further includes non-transitory computer executable instructions which, when executed by microprocessor/GRU 1041 performs all computer vision algorithms such as algorithms 1100-1400 disclosed later in FIG. 11-FIG. 14 of the present invention. Postal service module 1090 is in communication with memory 1070 via a bus 1062. Postal service module 1090 includes command analyzer module 1091, a flight controller module 1092, an object avoidance module 1093, remote control module 1094, and a RCNN autonomous flight module (auto pilot) 1095. In at least one of the various embodiments, while they may be illustrated here as separate modules, command analyzer module 1091, flight controller module 1092, object avoidance module 1093, remote control module 1094, and RCNN autonomous flight module 1095 may be implemented as the same module and/or components of the same application. Further, in at least one of the various embodiments, command analyzer module 1091, flight controller module 1092, object avoidance module 1093, remote control module 1094, and RCNN autonomous flight module 1095 may be implemented as operating system extensions, modules, plugins, applications, or the likes. In at least one of the various embodiments, command analyzer module 1091, flight controller module 1092, object avoidance module 1093, remote control module 1094, and RCNN autonomous flight module 1095 may be implemented as hardware devices such as on-board computer or application specific integrated circuit (ASIC), combinatorial logic circuits, field programmable gate array (FPGA), software applications in Python, C++, Java, and/or the combination thereof. Onboard computer 1040 further includes radars 1051, an electronic speed control (ESC) 1096, a feedback loop control 1097. ESC 1096 communicates with flight controller module 1092, feedback loop control 1097, and drone control module 1050 to control the speed of drones 171, 271, or 274.

Continuing with FIG. 10, now the operations of system 1000 is described. Drone 171 is equipped with onboard computer 1040 described above. While still in central depots 1031-1035, command analyzer module 1091 analyses a command loaded to drone 171 using scanner 1046. In various exemplary embodiments of the present invention, a command includes, inter alia, a (1) start section, (2) an 7-10 bit address frame, (3) a read and write (R/W) section, (4) an acknowledge and non-acknowledge (ACK/NACK) section, (5) a first data frame section, (6) a second acknowledge and non-acknowledge (ACK/NACK) section, (7) a second data frame section, (8) a third acknowledge and non-acknowledge (ACK/NACK) section, and (9) a stop section. First data frame section and second data frame section contain the address of high-rise building complexes 1021-1 to 1021-N, the customer delivery addresses (e.g., 611-4) or pickup address (e.g., 611-2). Drone 171 is flown by either remote control mode or auto pilot mode (fully autonomous flight). In many embodiments of the present invention, drone 171 is flown in the remote control mode using Ardupiplot Heralink software. That is, drone 171 is flown by a remote controller in central despots 1031-1035. In other embodiments, drone 171 is flown in auto pilot or in full autonomous flight mode using RCNN auto fly module 1095 with the assistance of radars 1051. In the auto pilot mode, flight controller module 1092—also known as mission planner—uses the detected addresses to plan out either delivery cycle D or pickup cycle PU using GPS unit 1048. In cooperation with RX datalink module 147, ESC 1096, feedback loop 1097, and with drone control module 1050, collision avoidance module 1093 broadcasts its flight route to other central depots 1031-1035 and to other drones in the vicinity so that central depots 1031 to 1035 can pre-plan the fly steps 101d, 105d, 105pu, 206, and 209 for each drone that minimize the probabilities of collisions. In addition, radars 1051 constantly sense moving and/or static objects from a distance away. If unwanted objected are detected, collision avoidance module 1093 adjusts the directions and velocity of drone 171 using the feedback loop 1097, ESC 1096, and drone control module 1050. In many preferred embodiments of the present invention, drone 171 is equipped with radars 1051 that are mounted on Cameo™ gimbals. These Cameo™ gimbals are designed so that radars 1051 operated in monocular mode or binocular mode analogous to the eyes of chameleons. Both modes can detect objects to avoid collisions. The Cameo™ gimbal system is disclosed in a patent application entitled, “Chemeleon-Eyes Gimbal System (Cameo™ Gimbal System) and Method of Manufacturing and Using the Same” by the same inventor, copending with the present application. The entire Cameo gimbal™ disclosure is incorporated herewith in its entirety. In either remote control mode or auto pilot mode, drone 171 is a Hera® drone invented by the same inventor.

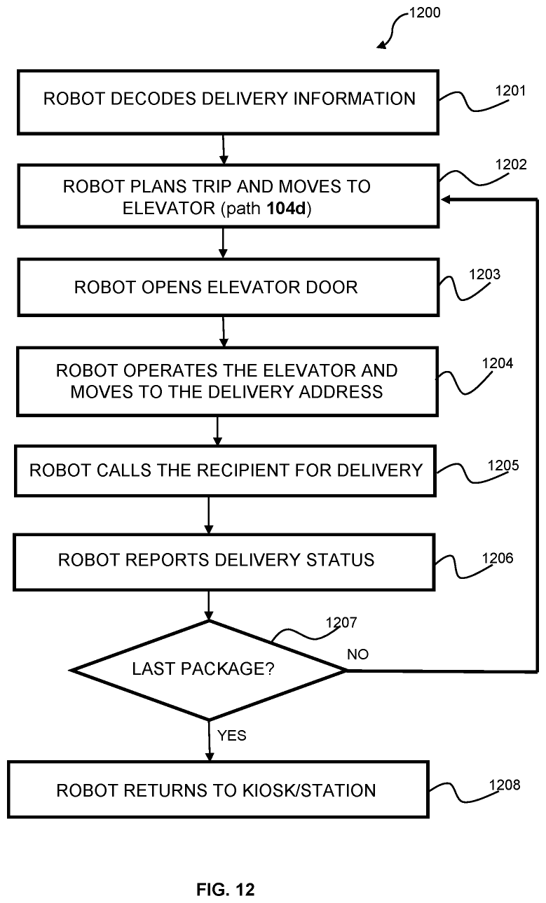

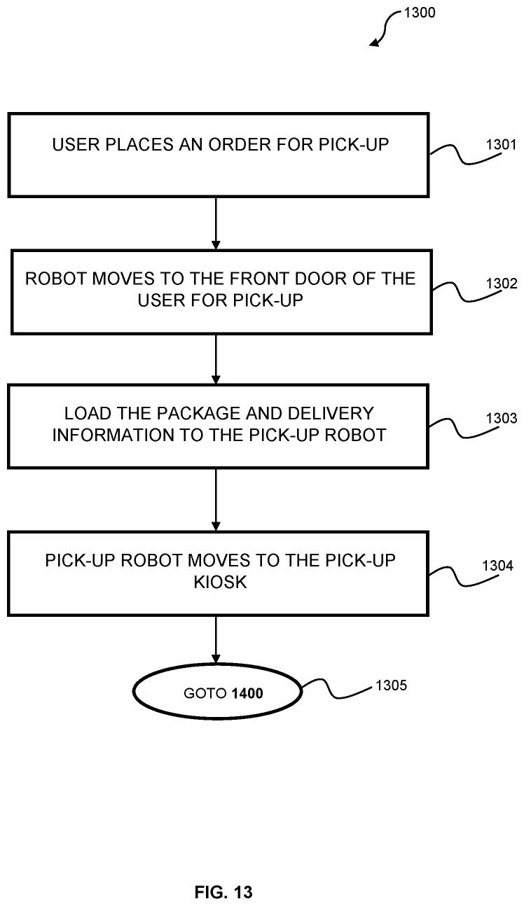

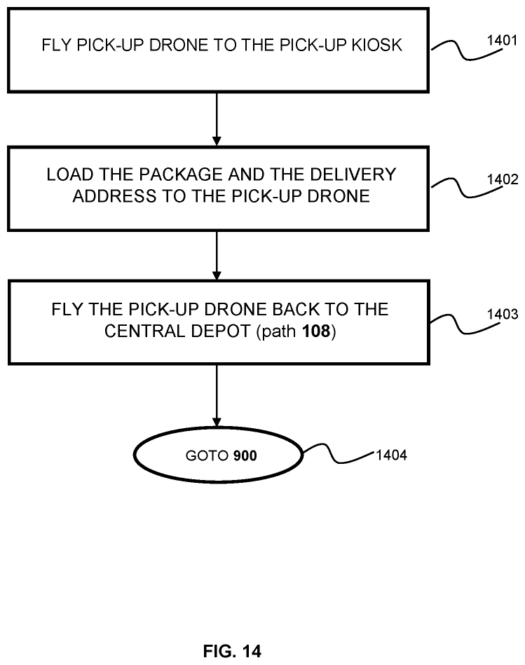

Now referring to FIG. 11, a flow chart of a method 1100 for delivering postal package(s) to a predetermined safe landing site in a high-rise building complex using drones or unmanned aerial vehicle (UAV) in accordance with an exemplary embodiment of the present invention is illustrated. It is noted that postal package(s) include but not limited to ordered foods, drinks, postal mail packages such as clothing units, shoes, toys, and other online merchandises. It is noted that FIG. 11-FIG. 12 describe steps for delivery cycle D outlined in FIG. 1 and FIG. 2 above. FIG. 13-FIG. 14 describe pickup cycle PU.

At step 1101, postal packages and delivery information are loaded into a delivery drone. Step 1101 is realized by drone 171 and system 1000. In many preferred embodiment of the present invention, delivery drone is a Hera© described earlier in FIG. 8, delivery information includes package ID (postal package 142), high-rise building complex address (i.e., tower 110), floor number (floor 15), the customer name (John Smith), room number (611-4). In many preferred embodiments of the present invention, drone 171 is the Hera© drone invented by the same inventor and manufactured by Real-time Robotics (RtR©) company. The Hera© drone is disclosed fully in a patent application entitled “Method for Destroying the Enemy's Targets Using Missiles Launched from Drones Carried Inside Soldiers' Packbacks”, filed on Jul. 17, 2022, application Ser. No. 17/813,042 by Quoc D. Luong. The entire patent application is attached herewith in its entirety herewith for reference.

Next at step 1102, the postal packages are physically loaded to the drone for delivery. Step 1102 is realized by humans or by a robotic systems that are designed to load postal packages to the drones. Loading robotic systems are located at central depots 1031-1035. Step 1101 is included in steps 101d of FIG. 1 and step 201 in FIG. 2.

At step 1103, the drone loaded with postal packages is flown to the high-rise building complex to a predetermined safe landing site. Step 1103 is realized by the Hera® drones that are either operated by remote control mode or by autonomous flight mode. The predetermined safe landing site in step 1103 is either on top of distribution kiosk 151 or safe zone 171 in FIG. 2. Step 1103 achieves the safe delivery objective of the present invention. Step 1103 is also described in step 101d in FIG. 1 or step 201 in FIG. 2.

Next at step 1104, after the drones are safety landed in the predetermined safe landing site, the postal packages and delivery information are transferred to delivery robots. Step 1104 is realized by distribution kiosk 151 described in FIG. 1 and FIG. 3A-FIG. 3B or postal service agents 281 or by other robotic and automation means in FIG. 2. Step 1104 is described in step 102d in FIG. 1 and step 203 in FIG. 2.

At step 1005, the delivery information is transferred or communicated to the delivery drones at the predetermined safe landing site. Step 1005 is realized by drone 171 and delivery robot 241 using scanner 831. Step 1104 and step 1105 are described in step 102d in system 100 of FIG. 1 or step 203 in system 200 of FIG. 2.

After step 1105, the delivery of the postal packages is realized by robots. Next, method 1200 begins.

Now referring to FIG. 12, a method 1200 of delivering postal packages to the frontdoor of the customers who live in a high-rise building complex by delivery robots in accordance with an exemplary embodiment of the present invention is illustrated. Method 1200 outlines another phase of door-to-door delivery using the special delivery robot that can autonomously operate the elevator systems.

At step 1201, delivery information is decoded by the delivery robot. Step 1201 is performed by command processing unit 832 of robot 900. Please refer back to FIG. 8 and FIG. 9. The delivery information includes name of customer addressee, room number, floor number, and postal package ID number. At central depots 1031-1035, the delivery information is encoded in the command. In various embodiments of the present invention, command processing unit 832 analyses and the command, during which counts the total number of packages to be delivered, total number of floors that include all delivery postal package(s) 142, and then establish moving trajectories.

At step 1202, the delivery trip is planned by the delivery robot. Step 1202 is also performed by command processing unit 832 configured to provide an optimal top-down step. The optimal trajectories includes (a) trajectory 422 to elevator system 401 and trajectory 622 (b) starting from top destination floor first, (c) delivering all postal packages on the same floor first; (d) trajectories 623 return to elevator 603 to each door on the same floor for all floors.

At step 1203, elevator door is opened for the delivery robot. Step 1203 is realized by delivery robot 900 using robotic arm 921. Robotic arm 921 operates as described in FIG. 9. In some other aspects of the present invention, elevator door 402 may be opened using smart elevators that are communicating with delivery robots. Yet in some other aspects, elevator door 402 can be opened by modified elevators that are coupled to a communication module that can communicate with delivery robots. Example of modified elevators include KONE© elevators and elevators made for smart buildings and smart homes. Yet in some other aspects of the present invention, postal service agents 281 can open the elevator door 202 and accompany robot 900 to each destination room, e.g., room 611-4.

Next at step 1204, the elevator is operated to reach the frontdoor of the customer. In various preferred embodiment of the present invention, step 1204 is realized by delivery robot 900 using robot arm 921. Robotic arm 921 operates as described in FIG. 4-FIG. 9. In some other aspects, elevator door 402 may be opened using smart elevators that are communicating with robot 171 embodied by robot 900. Yet in some other aspects, elevator door 402 can be opened by modified elevators that are electrically coupled to a communication module that can communicate with delivery robots 900. Yet in some other aspects of the present invention, postal service agents 281 can open the elevator door 402 and accompany robot 900 to each destination room, e.g., room 611-4. Step 1204 is further realized by elevator processing module 810. After selecting floor number using robot arm 921, robot 900 exits elevator 603 and moves along planed trajectory 622 to destination address 611-4. Autonomous driving module 820 renders step 1204 possible by following trajectory 622 and avoiding obstacles using inertia navigation system (INS) 824, LiDAR sensor feedback circuit 825, radars 1051, and motor driver firmware 826.

At step 1205, the customer is contacted by the delivery robot as the delivery robot arrives at the front door of the customer. Step 1205 is realized by communication interface module 830 when the customer is contacted by robot communication unit 833.

At step 1206, the delivery status is reported to the base by the delivery drone. Either the delivery drone successfully delivers the postal package to the customer or it leaves the postal package in the front door is reported to the base. This is achieved by robot communication unit 833. If the addressee requests personal pick up, delivery robot shall bring back the package if the addressee does not answer phone call 521. This is also reported. Otherwise, delivery robot 900 leaves the postal package at frontdoor 702. If the customer answers phone call 751 and comes out to pick up the postal package 142, this is also reported in a coded message (i.e., “1”) back to central depots 1031-1035.

At step 1207, whether last postal package is delivered is determined. Step 1207 is realized by drone command processing unit 832 which counts and keeps tracks as each delivery postal package 142 is delivered to each customer.

At step 1208, if the last delivery postal package(s) is delivered, delivery robot goes back to either the docking station or the distribution kiosk of the high-rise building complex. Again, step 1208 is realized by delivery robot 900 going back to distribution kiosk 151 or docking station 251 using elevator module 810, and autonomous driving module 820.

Thus, method 1100 and method 1200 achieve the following objectives of the present invention:
(a) safe and accurate door-to-door delivery to customers who live in high-rise building complexes;
(b) Problems and mishaps caused by balcony delivery drones are obviated; and (c) Full automation of postal packages pickups and deliveries are realized.

Now referring to FIG. 1300, a flow chart of a method 1300 for ordering and picking up postal packages by a resident in a high-rise building complex using drones or unmanned aerial vehicle (UAV) in accordance with an exemplary embodiment of the present invention is illustrated. It is noted that postal packages include ordered foods, drinks, mail packages such as clothing units, shoes, toys, and other ordered or returned items.

At step 1301, an order to pick up postal packages are placed by a customer (or sender). Step 1301 is realized by system 1000. A customer living in high-rise building complexes 1021-1, 1021-2, . . . , 1021-N in area 1020 makes a call for an order for pickup and delivery to central depots 1031-1035 via network 1010. As described earlier in FIG. 10, delivery information includes package ID (142), high-rise building address (i.e., tower 110), floor number (floor 15), the customer name (John Smith), room number (611-4). This information is scanned into drone 171 using scanner 1046. In many preferred embodiments of the present invention, pickup drone 171 is the Hera© drone invented by the same inventor and manufactured by Real-time Robotics (RtR©) company. Command analyzer 1091 uses this information to form a fly step such as 206 in PU cycle in FIG. 2. As mentioned above, fly trajectory is formed by flight controller 1092 which is a mission planner. As alluded above, flight controller 1092 is an Ardupilot with a mission planner being a QGround control. Both are opensource firmware.

Next at step 1302, the pickup robot moves to the frontdoor of the customer for picking up. Referring back to FIG. 9, robot 900 (or 741) arrives at front door 702 of room number 04 701. Front camera 922 mounted on robotic arm 921 sees front door 701 with handle 702 and room number sign 703, which constitutes an image stored in memory unit 816. Object detection and localization module 801 uses R-CNN algorithms detects this image. Then, robot communication unit 833 makes a phone call to the customer.

At step 1303, the postal package to be sent is loaded onto the pickup robot and the delivery information is scanned in. Step 1303 is realized the operations of distribution kiosk 151 described in FIG. 1, FIG. 3A-FIG. 3B and robot 900 which is fully disclosed in FIG. 8 and FIG. 9. In various embodiments of the present invention, the customer loads postal package 142 onto robot 141 (or robot 274 in FIG. 2). In other embodiments, postal service agents 281 loads postal package 244 onto robot 243. Yet in other embodiments of the present invention, robot 171 picks up postal package 244 by itself.

Next at step 1304, the pick-up robot moves to either the distribution kiosk or a predetermined safe landing zone. Step 1304 is realized by step 105 in FIG. 1. Alternatively, step 1304 is realized by steps 207 and 208 described in FIG. 2. During step 1304, robot 171 embodied by robot 700 follows trajectory 623 to elevator 602 or elevator 603. Then, robot 141 operates elevator operation panel 511 as described above in FIG. 5 using elevator processing unit 811. But this time it is going to distribution kiosk 151.

Continuing with step 1304, after the drones are safety landed in the designated safe landing site or on top of distribution kiosk, the postal packages and delivery information are transferred to delivery robot 900 by scanning the QR code on scanner 831 using the smart phone or the printout of the customer. The physical transfer of postal package 244 of step 1304 is realized by distribution kiosk 151 or by postal service agents 281 or by other robotic means.

After step 1304, the postal package is flown back to central depots 1031-1035. Next, method 1400 begins.

Now referring to FIG. 14, a method 1400 of flying the postal packages to the central depot for processing and administration in accordance with an exemplary embodiment of the present invention is illustrated. Method 1400 outlines PU cycle described in system 100 of FIG. 1. Alternatively, method 1400 outlies PU cycle which include steps 207-208 illustrated in FIG. 2.

At step 1401, a pickup drone is flown to a distribution kiosk or a predetermined safe landing site of one of the high-rise building complex. Step 1401 is realized by drone 171, drone 274 realized by Hera® drone equipped with and system 1000. After the order of the customer is processed, a drone such as drone 171 is commissioned to pick up postal package 142 to one of high-rise building complex 189. First, the command includes the name of customer addressee, room number, floor number, and postal package ID number. The delivery information is encoded in the command that is created at central depots 1031-1035. In various embodiments of the present invention, command analyzer unit 1091 analyses and the command, during which counts the total number of packages to be delivered, total floors, and then arrange an optimal top down step. Next, the pickup trip is planned by the pickup drone 141 or drone 274. Step 1401 is also performed by flight controller unit 1092 configured to provide a mission planner. The mission planner includes flight trajectory to predetermined safe landing site 275 (step 206). Alternatively, the mission planner includes flight trajectory from central depot 199 to the top of distribution kiosk 151 in FIG. 1 (step 101pu).

At step 1402, at the arrival of the pickup drone, the postal package is transferred from the pickup robot to the pickup drone. Step 1402 is realized by robot 341 moving inside distribution kiosk 300A or 300B via door 301. Robotic arm 321 transfers postal package 142 from robot 341 to one of slot boxes 311-1 to 311-K. When drone 371 with gripers 372 arrives and lands over opening 303, robotic arm 321 removes postal package 142 from slot boxes 311-1 to 311-K and communicates with drone 371. Gripers 372 grasps postal package 142 firmly and takes off. Alternatively, in another aspect of the present invention, step 1402 is realized by robot 243 from docking station 273 to meet up with pickup drone 274 at predetermined safe landing site 275. The trajectory of pickup drone 274 includes step 207 and step 208. Again, pickup robot 243 is embodied by drone 900 which operates in conjunction with system 1000. Pickup robot 243 is autonomous driving from the frontdoor to predetermined safe landing site 275. The autonomous driving of pickup robot 243 embodied by robot 900 is described in details above. The transfer of pickup postal package 244 from pickup robot 243 to pickup drone 274 in system 200 may be performed by postal service agents 281 or by other robotic arm or other automatic means. Please refer to FIG. 2 for more details.

Finally, at step 1403, the pickup drone is flying back to the central depot for administration and other managerial tasks. Step 1403 is realized by system 1000 via step 105pu as described in FIG. 1. After gripers 372 obtain postal package 142, drone 371 flies back to central depot 199. Alternatively, in another aspect of the present invention, step 1403 is realized by step 209 described in system 200 in FIG. 2. Pickup drone 274 is either flown in remote control mode or autonomous flight mode. After pickup drone 274 arrives back at central depot 199. Administration and management tasks include confirmation of the order, payments, quality controls, and safe contents of postal packages 244. Thus, method 1300 and method 1400 achieve the following objectives of the present invention: After the administration and management tasks have been performed, the delivery cycle as described in D cycle and method 1100 begin again.
(a) safe and accurate door-to-door pickup for customers who live in high-rise buildings complexes;
(b) Problems and mishaps caused by balcony delivery drones are obviated; and
(c) Full automation of postal packages deliveries are realized.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should, therefore, be construed in accordance with the appended claims and any equivalents thereof.

### DESCRIPTION OF NUMERALS

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should, therefore, be construed in accordance with the appended claims and any equivalents thereof.
100 drone-robot pickup and delivery system using distribution kiosk
101d flight from central distribution to distribution kiosk
102d loading and moving robot out of distribution kiosk
103d robot with postal packages on delivery assignment
104d robot on delivery inside building
105d delivery drone flies back to central kiosk
101pu robot picks up postal packages at front door
102pu moving robot out of building
103pu robot with postal packages moves inside distribution kiosk
104pu distribution kiosk transfers postal packages to drone
105pu drone flies back to central kiosk
106 drone fly back to central depot
111-1 first floor
111-2 second floor
111-3 third floor
111-N N^{th} floor
112 front entrance to first tower
113 elevator system
121 second high-rise tower
122 front entrance to second tower
131 third high-rise tower
132 front entrance to third tower
141 pickup and delivery robot
142 pickup and delivery postal packages
151 smart distribution kiosk for drone-robot
151 delivery robot in connection with delivery drone
171 pickup/delivery drone
198 high-rise building complex
199 central depot
200 drone and robot pickup and delivery system in high-rise buildings
201 delivery drone flies to high-rise building complex
202 delivery robot moves to meet up with delivery drone
203 transfer of delivery package(s) to delivery robot
204 delivery robot moves to deliver
205 delivery drone flies back to central depot
206 pickup drone flies to pickup area
207 pickup robot moves to pickup drone
208 pickup robot handles postal packages over to drone
209 pickup drone with postal packages flies back to central depot
241 delivery drones
242 delivery postal packages
251 docking station for delivery robots
271 delivery drone
273 docking station for pickup robots
274 pickup drone
275 predetermined safe landing site (pickup zone)
281 postal service agents
300A 3D (smart) distribution kiosk
300B 2D layout of distribution kiosk
301 storage house
302 entrance door
303 top opening
304 slide cover
305 first pulley
306 second pulley
307 DC motor for slide cover
311-1 first slot box for storing postal packages
311-2 first slot box for storing postal packages
311-K Kth slot box for storing postal packages
321 robotic arm
322 support platform
323 controller for robotic arm
331 slider
332 slot box platform
333 slider wheel
334 slider wheel
335 DC motor for slider
341 robot associated with distribution kiosk
371 drone that docks with distribution kiosk
372 gripers
400 second phase where robot is in front of elevator
401 elevator
402 elevator door
403 down button
404 up button
422 delivery robot's step to elevator
423 delivery robot's return step
441 delivery robot inside tower
442 robotic arm
500 third phase where robot is inside elevator
501 interior of elevator
502 close door button
503 open door button
504 emergency stop button
505 call button
511 elevator operation panel
511-1 first floor button
511-2 second floor button
511-15 15^{th} floor button
511-N Nth floor button
541 delivery drone inside elevator
542 robotic arm about to select destination floor
600 floor plan of the destination floor (selected floor)
601 floor plan
602 first elevator unit
603 second elevator unit
604 third elevator unit
605 fourth elevator unit
606 utility and electrical rooms
611-1 first room (room #1)
611-2 second room (room #2)
611-3 third room (room #3)
611-4 fourth room (room #4)
611-5 fifth room (room #5)
611-6 sixth room (room #6)
611-7 seventh room (room #7)
611-8 eighth room (room #8)
611-9 ninth room (room #9)
611-10 tenth room (room #10)
611-11 eleventh room (room #11)
611-12 twelfth room (room #12)
621 delivery robot on the destination floor
622 delivery robot step to the customer's frontdoor
623 robot delivery step back to kiosk
641 robot inside floor plan
700 fourth phase (final phase) customer's frontdoor
701 customer's frontdoor
702 door handle
703 door room number
741 delivery robot at destination
751 drone communication signals
800 robot system controller
801 object detection module
810 elevator processing module
811 elevator processessing unit
812 arm controller firmware
813 robot arm motor
814 XYZ coordinate unit
815 feedback unit
816 memory unit
820 autonomous driving module (auto pilot)
821 autonomous driving processor
822 3D map model
823 GPS unit
824 inertia navigation system (INS)
825 sensor feedback circuit
826 motors
827 electronic speed controller (ESC)
830 communication interface module
831 scanner
832 command processing unit
832 command processing unit
833 robot communication unit
834 delivery status unit
900 structure of pickup and delivery robot
901 chassis
902 wheels
903 axels
904 postal package container area
905 battery
906 linear slide rack
907 pinion
911 DC motor
912 DC motor
913 DC motor
914 spur gear
921 robotic arm
922 front camera(s)
923 sensor
924 sensor
925 sensor
926 rear camera
927 inertia navigation system (INS)
928 electronic speed control (ESC)
1000 pickup and delivery network
1010 network such as cloud network
1020 area
1021-1 HBC1
1021-2 HBC2
1021-N HBCN
1031 first central depot in a given region or district.
1032 second central depot
1033 third central depot
1034 fourth central depot
1035 third central depot
1040 drone onboard computer
1041 microprocessor/graphic processor unit (GRU)
1042 power management unit (PMU)
1043 network interface
1044 ROM/RAM
1045 display screen
1046 scanner
1047 R/X datalink
1048 GPS unit
1049 I/O interface
1050 drone control module
1051 radars
1061 communication link
1062 bus
1070 memory
1071 operating system (O/S)
1072 BIOS
1080 data storage
1081 sample dataset
1082 training dataset
1090 postal service module
1091 command analyzer
1092 flight controller (mission planner)
1093 collusion avoidance module
1094 remote control module
1095 RCNN autonomous flight module (auto pilot)

1. A method for full door-to-door pickup and delivery services of postal packages to customers living in a high-rise building complex, comprising:
(a) flying a drone to and from a central depot to deliver said postal packages to a designated location located in said high-rise building complex; and
(b) causing a robot to directly receive said postal packages from said drone at said designated location and deliver to front doors of said customers, wherein said robot is capable of autonomously control elevators in said high-rise complex and move up and down between floors to deliver said postal packages to said front doors of said customers on the same floor first; and
(c) causing said robot to automatically control said elevator to pick up postal packages to be picked up at said front doors of said customers who live on the same floor first and then causing said robot to move to said designated location where said drone receives and transports said postal packages back to said central depot.

2. The method of claim 1
(d) wherein said designated location further comprises a delivery location located on the ground and a pickup location located on a rooftop of said high-rise building complex.

3. The method of claim 2 further comprising:
performing a delivery cycle which comprises flying said drone to deliver said postal packages to be delivered from said central depot to said first location and using said robot to deliver said postal packages to said front doors of said customers; and
performing a pickup cycle which comprises using said robot to pick up said postal packages to be picked up from said front doors of said customers and using said drone to transport said postal packages to be picked up to said second location and then to said central depot to get ready to be delivered to other high-rise complexes.

4. The method of claim 3 further comprising:
(e) contacting said customers when said robot arrives at said front doors of said customers; and
(f) reporting delivery and/or pickup statuses after transferring said postal packages to said customers.

5. The method of claim 4 wherein said step (a) further comprises electronically loading delivery and/or pickup information contained in each postal packages to said drone.

6. The method of claim 5 further comprising flying said drone carrying said postal packages to and from said central depot to said first location or said second location using a remote control.

7. The method of claim 2 further comprising autonomously flying said drone carrying said postal packages to and from said central depot to said first location or said second location.

8. The method of claim 5 wherein loading said delivery and/or pickup information further comprises: (i) providing coordinates of said central depot; (ii) providing coordinates for said first and second location; (iii) providing an identification number for each of said postal packages; (iv) providing a full name of each of said customers; (v) providing an apartment number for each of said customers; (vi) providing coordinates for said front doors; and (vii) said delivery and/or pickup statuses.

9. The method of claim 8 wherein said step of delivering said postal packages to said customers using said robot further comprises:
(i) moving said robot to said first location to meet up with said drone;
(j) autonomously moving said robot to a building where said customers live based on said delivery information, wherein said high-rise complex comprises a plurality of buildings;
(j) autonomously moving said robot through an entrance of said building;
(k) autonomously moving said robot to an elevator unit of said building;
(l) pressing an open door button of said elevator unit using a robotic arm of said robot;
(m) autonomously entering inside said elevator unit of said building;
(n) selecting a floor where said customers live using said robotic arm;
(o) pressing a close door button inside said elevator unit;
(p) delivering all of said postal packages to said customers on the same floor first; and
(q) repeating steps (k) to (p) for lower floors.

10. The method of claim 7 wherein said step of picking up said postal packages from said customers using said robot further comprises:
(r) autonomously moving said robot to a building where said customers live based on pickup information;
(s) autonomously moving said robot through an entrance of said building;
(t) autonomously moving said robot to an elevator unit of said building;
(u) pressing an open door button of said elevator unit using a robotic arm of said robot;
(v) autonomously entering inside said elevator unit of said building;
(w) selecting a lowest floor where said customers live using said robotic arm;
(x) pressing a close door button inside said elevator unit;
(y) collecting all of said postal packages to said customers on the same floor first;
(z) repeating steps (k) to (p) for higher floors;
(r) moving said robot to said second location on said rooftop;
(s) flying said drone to said second location to meet up and transfer said pickup postal packages from said robot to said drone.

11. The method of claim 10 further comprising:
(p) exiting said elevator unit as a door of said elevator unit opens upon reaching said floor.

12. The method of claim 11 further comprising:
(q) autonomously moving said robot to said front doors of said customers.

13. The method of claim 1 wherein said designated location is a kiosk capable of storing and automatically transferring/receiving said postal packages from said drone and to said robot and vice versa using a second robotic arm electrically and mechanically coupled to said kiosk.

14. The method of claim 13 wherein said step of delivering and/or picking up said postal packages to said customers using said robot further comprises: flying said drone to park on top of said kiosk to deliver and/or pick up said postal packages to said kiosk.

15. A system, comprising:
(a) a drone designed to deliver and pick up postal packages from a central station to a designated location located in a high-rise building complex; and
(b) a robot designed to deliver said postal packages from said designated location to front doors of customers who live in said high-rise building complex, wherein said robot is capable of autonomously control elevators in said high-rise complex and move up and down between floors to deliver/pick up said postal packages to/from said front doors of said customers; and wherein said robot starts from a highest floor where at least one of said postal packages are to be delivered to one of said customers; and delivering all of said postal packages to said customers who live on the same floor firs.

16. The system of claim 15 wherein said robot further comprises:
(c) a robotic arm configured to physically operate an elevator unit of said high-rise building complex; and
(d) a controller unit configured to (i) enable said delivery robot to autonomously navigate from a docking station to said designated location and then to said front doors of said customers, and (ii) guide said robotic arm to correctly operate said elevator unit.

17. The system of claim 16 wherein said controller unit further comprises:
an artificial intelligence (AI) unit configured to enable said robot to recognize different signs inside said high-rise building complex;
an elevator operation unit, in communication with said AI unit, configured to drive said robotic arm to correctly operate said elevator unit;
an autonomous driving unit, in communication with said AI unit, configured to enable said robot to autonomously drive from said docking station to said designated location, receiving said postal packages from said drone, and then to said front doors of said customers; and
a communication interface unit configured to process said delivery information and to communicate with a central station regarding a delivery status of said postal packages.

18. The system of claim 17 wherein said AI unit further comprises a plurality of cameras configured to provide image information of surroundings inside said high-rise building complex.

19. The system of claim 17 wherein said elevator operation unit further comprises:
an arm controller unit configured to store a firmware that controls said robotic arm;
a robot arm actuator configured to operate said robotic arm upon receiving said firmware;
an XYZ coordinate unit configured to provide exact locations of said signs posted inside said high-rise building complex; and
an elevator processor unit configured to receive information from said AI unit, said arm controller unit, and said XYZ coordinate unit to operate said robotic arm.

20. The system of claim 15 wherein said autonomous driving unit further comprises:
an autonomous driving processor unit;
a 3D map model unit configured to provide a model of said surroundings inside said high-rise building complex;
a recurrent convolutional neural network (RCNN) unit operable to guide said robot along said surroundings inside said high-rise building complex;
LiDAR sensors configured to provide information regarding obstacles in said surroundings; and
a plurality of motors operable to autonomously drive said robot.
